(19) United States
(12) Patent Application Publication
(10) Pub. No.: US 2024/0339687 A1
(43) Pub. Date: Oct. 10, 2024

(54) Serviceable Batteries with Reusable Electrodes

(71) Applicant: QuanVerge Inc., Reno, NV (US)

(72) Inventor: Stephen Robert Clarke, Reno, NV (US)

(73) Assignee: QuanVerge Inc., Reno, NV (US)

(21) Appl. No.: 18/293,962

(22) PCT Filed: Jul. 25, 2022
(86) PCT No.: PCT/US2022/038210

§ 371 Date: Jan. 31, 2024

Related U.S. Application Data
(60) Provisional application No. 63/228,897, filed on Aug. 3, 2021.
(60) Provisional application No. 63/333,892, filed on Apr. 22, 2022.

(51) Int. Cl. H01M 10/54; H01M 4/02; H01M 4/14; H01M 4/21; H01M 4/62; H01M 10/08; H01M 10/14; H01M 10/16; H01M 10/18; H01M 50/437; H01M 50/494

(52) U.S. Cl. CPC H01M 10/54; H01M 4/14; H01M 4/21; H01M 4/626; H01M 10/08; H01M 10/14; H01M 10/16; H01M 10/18; H01M 50/437; H01M 50/494; H01M 2004/029

(57) ABSTRACT

Various systems and methods are presented in which lead acid batteries are serviced by removal, reconditioning, and refilling reconditioned battery paste into an assembly of typically bipolar electrodes that may be retained in a reusable housing and/or compression mechanism. Preferably, such batteries will include electrodes having a layer of a Magneli phase of a transition metal suboxide to so provide enhanced electrochemical and mechanical strength. and the battery paste may further include porous particles a Magneli phase of a transition metal suboxide to so provide enhanced electrolyte performance.

This application claims priority to our copending U.S. provisional patent applications with the Ser. Nos. 63/228,897, filed Aug. 3, 2021, and 63/333,892, filed Apr. 22, 2022, both of which are incorporated by reference herein.

### FIELD OF THE INVENTION

The field of the invention is rechargeable energy storage devices and methods for servicing such devices, especially as it relates to lead acid batteries with bipolar configuration that can be readily disassembled, serviced, and reassembled for continued use.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Despite their simplicity and typically robust construction, lead acid batteries will deteriorate over time and the most common modes of failure can be attributed to degradation of the electrodes and active material. Historically, most monopolar lead acid batteries were recycled using smelting operations. However, smelting is problematic due to toxic emissions and high energy consumption, and various attempts have been made to use more environmentally friendly solutions. For example, U.S. Pat. No. 4,927,510 and CA 1310837 teach recovering substantially all lead in pure metal form from battery sludge after a desulfurization process. The paste is first leached with an acid suitable for electrowinning and insoluble PbO2 is reduced using hydrogen peroxide. Unfortunately, the '510 patent and the '837 patent require use of a fluorine containing electrolyte (e.g., fluoboric, fluosilic acid), which is environmentally equally problematic.

To overcome some of the difficulties associated with fluorine containing electrolytes, desulfurized lead active materials have been dissolved in methane sulfonic acid as described in U.S. Pat. No. 5,262,020 and U.S. Pat. No. 5,520,794. However, as lead sulfate is rather poorly soluble in methane sulfonic acid, upstream pre-desulfurization is still necessary and residual insoluble materials typically reduced the overall yield to an economically unattractive process. To improve at least some of the aspects associated with lead sulfate, oxygen and/or ferric methane sulfonate can be added as described in WO 2014/076544, or mixed oxides can be produced as taught in WO 2014/076547. However, despite the improved yield, several disadvantages nevertheless remain. Among other things, solvent reuse in these processes often requires additional effort, and residual sulfates are still lost as waste product.

In another known process, U 8409421 teaches an electrolytic process for recovering lead from desulfurized lead paste. The lead paste is leached with a solution comprising ammonium chloride to form a two-phase reaction product. The solid phase of the reaction product is leached with hydrogen peroxide to reduce insoluble PbO₂ and form a second two-phase reaction product. The liquid phases of the two reactions products are subject to electrolysis to form spongy lead. However, the '421 patent teaches that CO₂ is produced in the first leaching step and that it is necessary to add ammonia and water during electrolysis to make up for consumed ammonia and evaporated water in the electrolysis step, which can be problematic.

In yet a further known processes, as described in International Patent Publication WO 2016/081030 and 2016/183428, upstream desulfurization and use of methane sulfonic acid was employed in a continuous electrochemical process that could recover highly pure lead from desulfurized battery paste. While advantageous from various aspects, various difficulties nevertheless remained. Among other issues, recovery of pure lead still required considerable amounts of energy, and the electrodes and grids still required separate processing.

These difficulties are further compounded where the batteries are lead bipolar batteries, and among other problems, assembly and disassembly of bipolar batteries is often problematic due to the tendency to leak. Worse yet, commonly used bipolar electrodes typically lack the mechanical resiliency to withstand the assembly and disassembly operations and removal of the lead paste and crystals from the bipolar electrode readily damages the metallic lead layer on these electrodes.

To overcome at least some of the difficulties associated with battery assembly and mechanical stability, a bipolar lead acid battery with a compression resistant separator was manufactured in which the electrolyte was retained in a gelled form, and wherein quasi-bipolar electrodes were maintained in a cell stack under pressure as is described in WO 2010/019291. In such assemblies, the negative active material further included a compression resistant spacer structure, and the battery was configured as a VR-BLAB where each single cell was able to independently vent gases during the charge cycle. The electrodes in these batteries were configured as quasi-bipolar electrodes in which openings in a nonconductive carrier were filled with a conductive material that was then overlaid on both sides of the carrier with a thin lead foil. In another example, bipoles in a lead acid bipolar battery were constructed from thin lead substrates that were supported by non-conductive (typically plastic) frames that gave structural stability to accommodate stress and strain in a bipole assembly as described in WO 2011/109683. While such arrangement reduced the overall weight of the battery and increased mechanical stability, the thin lead substrates on the bipolar electrodes remain prone to damage and puncture during assembly and operation.

Similarly, as described in U.S. Pat. No. 5,126,218, electrically conductive plugs comprising sub-stoichiometric titanium dioxide materials were used to produce a non-conductive light-weight carrier that included multiple conductive pathways connecting both sides of the carrier. While such construction is beneficial for weight and corrosion resistance, the current flow across such bipoles is typically limited. U.S. Pat. No. 7,033,696 avoids the use of conductive plugs and instead uses glassy carbon or Magneli phase particles embedded in a polymeric carrier to thereby form a bipolar electrode in a cerium zinc battery. Once more, however, current flow is significantly limited in such electrodes as the conductive pathways across the polymeric carrier is formed only at the contact faces between the conductive particles. To increase the current flow across bipoles, a bipole can be constructed as a monolithic composite lead/lead alloy foil as taught in WO 2012/158499. However, the complexity of manufacture and assembly into a battery with such bipoles is often undesirably high. Moreover, due to the use of lead materials, the weight of the bipoles is increased relative to other methods.

Thus, even though various devices and methods of assembling bipolar lead acid batteries are known in the art, all or almost all of them suffer from several drawbacks, particularly where the bipoles require mechanical rigidity and high transverse current flow at the same time. Moreover, currently known bipole batteries are not suitable for disassembly and reassembly and use of reassembled batteries. Therefore, there remains a need for improved lead acid batteries with axial current flow that can be assembled, serviced, and disassembled while maintaining operational performance after multiple assembly-servicing-reassembly cycles.

### SUMMARY OF THE INVENTION

The inventive subject matter is directed to various systems, devices, and methods of reconditioning/reusing bipolar lead acid batteries in a conceptually simple and technically efficient manner that substantially reduces energy demand otherwise required for recycling and further reduces the demand for generation of new materials. In especially preferred aspects, used batteries are disassembled in a non-destructive manner, the active material of used batteries is removed from the batteries, reconditioned, and placed back into the batteries. Moreover, the electrodes of such batteries will also be corrosion resistant, reusable, and provide structural resilience to the battery to so allow for multiple disassembly/reassembly cycles.

In one aspect of the inventive subject matter, the inventor contemplates an axial current flow battery that includes a plurality of bipole electrodes, wherein each bipole electrode is in contact with positive active material (PAM) on a first surface area and negative active material (NAM) on a second surface area opposite the first surface area. In such batteries, each bipole electrode comprises a conductive substrate that is coated with a continuous layer of a Magneli phase transition metal oxide to so form the first and second surface areas, and each bipole electrode further comprises a seal that circumferentially encloses the PAM and/or the NAM. As will be readily appreciated, numerous other oxidation resistant materials can also be used and especially contemplated materials include various electrically conductive and oxidation resistant oxides of two or more metals of substantially different atomic radius, some examples being NbₓTi_{y}O_{z}, NbₐV_{b}O_{c} and Magneli Phase transition metal (sub) oxides, which may further comprise a second metal having a dissimilar atomic radius (e.g., Nb where the Magneli phase materials comprises titanium, vanadium, chromium, or manganese suboxides). A plurality of separators is further included, each being disposed between the PAM of one bipole electrode and the NAM of another bipole electrode. In addition, contemplated batteries include a frame and/or a housing, wherein the frame and/or the housing includes a compression mechanism that retains and compresses the plurality of bipole electrodes in a stacked configuration. Most typically, the conductive substrate and the continuous layer of the Magneli phase transition metal maintain structural and functional integrity over a plurality of disassembly-NAM/PAM replacement-reassembly cycles (e.g., at least ten) for the axial current flow battery.

In some embodiments, the conductive substrate is stainless steel, copper, aluminum, or titanium. Most typically, but not necessarily, the conductive substrate has a thickness of between 0.5 mm and 5 mm, and/or the continuous layer of the Magneli phase transition metal has a thickness of between about 10 and 2,500 nm. It is further contemplated that the first and second surface areas each have an area of between 50 cm² and 50,000 cm². In further preferred aspects, the Magneli phase transition metal is TiₙO₍₂ₙ₋₁₎ where (4≤n≤10) or VₙO₍₂ₙ₋₁₎ (3≤n≤9), and at least 80% of a surface area of the conductive substrate is coated with the Magneli phase transition metal. Where desired, the continuous layer of the Magneli phase transition metal may further include a metal catalyst (e.g., platinum, palladium, vanadium, ruthenium, and/or silver).

Suitable seals include elastomeric seals, which may be coupled to the bipole electrode via a seal retaining structure in the bipole electrode (e.g., configured as a labyrinth seal). Where desired, the separator may comprise a compression resistant material (e.g., an absorbent glass mat), and/or it is contemplated that the separator may also include a liquid or gelled electrolyte. In typical batteries, the frame and/or the housing will be configured to retain between 5 and 50 bipole electrodes, and/or the compression mechanism comprises a plurality of tension rods or one or more compression rams or compression levers.

In further contemplated aspects of the inventive subject matter, a compound axial flow battery may therefore comprise a plurality of axial current flow batteries as presented herein, which will be preferably electrically coupled to each other in series or in parallel. In further contemplated aspects, at least two of the axial flow batteries can be slidably coupled to each other between a first and second position, wherein the batteries are electrically connected to each other in the first position and electrically disconnected in the second position.

For example, and among other deployments, a load leveling station in a public utility power distribution network, an electric automobile charging station, or a residential power supply station may include a plurality of axial current flow batteries or compound axial flow batteries as presented herein.

In yet another one aspect of the inventive subject matter, the inventor contemplates a bipole electrode that includes a conductive substrate that is coated with a continuous layer of a Magneli phase transition metal to so form first and second surface areas for contact with a PAM and a NAM, respectively. Most typically, the bipole electrode further comprises a seal, optionally disposed in a seal retaining structure of the bipole electrode, wherein the seal circumferentially encloses the PAM and/or the NAM, and the conductive substrate and the continuous layer of the Magneli phase transition metal maintain structural and functional integrity over a plurality of disassembly-NAM/PAM replacement-reassembly cycles for an axial current flow battery containing the bipole electrode.

Most typically, the conductive substrate is stainless steel, copper, aluminum, or titanium, which may have a thickness of between 0.5 mm and 5 mm. In most exemplary configurations, the first and second surface areas each have an area of between 50 cm² and 50,000 cm², and the Magneli phase transition metal is TiₙO₍₂ₙ₋₁₎ where (4≤n≤10) or VₙO₍₂ₙ₋₁₎ (3≤n≤9). Where desired, the continuous layer of the Magneli phase transition metal may further include a metal catalyst selected form the group consisting of platinum, palladium, vanadium, ruthenium, and silver. In further typical embodiments, the continuous layer of the Magneli phase transition metal will have a thickness of between about 10 and 2,500 nm, and/or the seal is an elastomeric seal (e.g., configured as an O-ring, with a seal retaining structure configured as a gland for an O-ring). For example, the seal may have a rectangular or square shape.

In still another aspect of the inventive subject matter, the inventor contemplates a method of assembling an axial current flow battery, and especially contemplated methods include a step of providing a plurality of bipole electrodes, wherein each bipole electrode comprises a conductive substrate that is coated with a continuous layer of a Magneli phase transition metal to so form first and second surface areas on the bipole electrode. Positive active material (PAM) and negative active material (NAM) are then coupled to the first and the second surface areas, respectively, and a seal is coupled to each of the bipole electrodes, wherein the seal circumferentially encloses the PAM and/or the NAM. The plurality of bipole electrodes are then stacked, with two bipole electrodes being interlaced by a separator that separates that PAM on one bipole from the NAM on the other bipole, and the stacked bipole electrodes are then placed (during or after stacking) into a frame and/or a housing that comprises a compression mechanism, which is then used to retain and compress the bipole electrodes in the stacked configuration. As noted above, the conductive substrate and the continuous layer of the Magneli phase transition metal are configured to maintain structural and functional integrity over a plurality of disassembly-NAM/PAM replacement-reassembly cycles for the axial current flow battery. In addition, it should also be appreciated that such batteries have superior heat management and dissipation due to the generation of a continuous heat transfer path, and that no dedicated cooling circuits are required within the battery assembly (although a vented or ventilated cabinet may be used).

Most typically, but not necessarily, the conductive substrate is stainless steel, copper, aluminum, or titanium, and may have a thickness of between 0.5 mm and 5 mm. As also noted above, the first and second surface areas will typically each have an area of between 50 cm² and 50,000 cm², and the Magneli phase transition metal is TiₙO₍₂ₙ₋₁₎ where (4≤n≤10) or VₙO_{(2n-1) (}3≤n≤9). Where desired, the continuous layer of the Magneli phase transition metal further comprises a metal catalyst selected form the group consisting of platinum, palladium, vanadium, ruthenium, and silver, and/or the continuous layer of the Magneli phase transition metal has a thickness of between about 10 and 2,500 nm.

The PAM and/or the NAM can be coupled to the first and/or second surface areas by placing pre-shaped PAM and/or NAM wafers onto the first and/or second surface areas on the bipole electrode, and/or the seal can be coupled to the bipole by placing the seal into a gland for an O-ring. Most typically, the separator will comprise a compression resistant material (e.g., an absorbent glass mat) and may further include a liquid or gelled electrolyte. It is further generally preferred that between 5 and 50 bipole electrodes are being stacked, and/or that the compression mechanism uses a plurality of tension rods or one or more compression rams or compression levers.

Therefore, and viewed from a different perspective, the inventor also contemplates a method of servicing an axial current flow battery that includes a step of providing an axial current flow battery as presented herein, and a step of using the compression mechanism of the frame and/or the housing to decompress and release the plurality of bipole electrodes. In a further step, (a) the PAM and/or NAM with new or reconditioned PAM and/or NAM, (b) the seal, (c) the separator, and/or (d) the bipole electrode are replaced. The bipole electrodes with the new or reconditioned PAM and/or NAM, the replaced seal, and/or the replaced separator are then stacked and placed into the frame and/or the housing and the compression mechanism is used to retain and compress the bipole electrodes in the stacked configuration.

In especially contemplated embodiments, at least two or at least three of (a), (b), (c), and (d) can be replaced. Preferably, but not necessarily, the new or reconditioned PAM and/or NAM are provided as pre-shaped PAM and/or NAM wafers.

Therefore, the inventor also contemplates a method of servicing an energy consuming entity, wherein at least some of the energy used by the entity is provided by a battery. Such method will typically include a step of locating a battery in the entity, and optionally removing the battery from the entity, another step of replacing at least some of the active material of the battery with reconditioned active material. In cases where the battery was removed, the battery is the installed with the reconditioned active material, or a different replacement battery is installed that contains reconditioned active material. Finally, where desired, the battery or replacement battery is recharged.

For example, contemplated entities include a golf cart, an automobile, a truck, a train engine, a consumer power backup battery, a residential power supply battery, a grid load leveling battery, and an industrial power backup battery. Where desired, the reconditioned material may be prepared on site from the active material of the battery, or from an active material of a different battery. Therefore, the step of replacing at least some of the active material may be performed in or proximal to the energy consuming entity. As will be readily appreciated the above methods are especially suitable for execution under a service or lease contract.

In still another aspect of the inventive subject matter, the inventor contemplates a method of processing battery paste comprising lead sulfate crystals and lead dioxide crystals from a used lead acid battery that includes a step of providing or obtaining the battery paste. In a further step, the battery paste is comminuted to disintegrate at least some of the lead sulfate crystals and lead dioxide crystals, and the battery paste, or comminuted battery paste is optionally washed. For example, the battery paste may be comminuted to an average particle size of between 50-300 μm. Such reconditioned battery paste is suitable for use in a battery.

Consequently, and especially where axial flow batteries as described herein are used, the step of providing or obtaining can advantageously performed in a non-destructive manner. In some embodiments, the battery paste is washed before the step of comminuting, and/or the battery paste is washed after the step of comminuting. Preferably, but not necessarily, the materials can be washed with water, citric acid, and/or sulfuric acid, or with a deep eutectic solvent including Type I, Type II, Type III or Type IV salts. Where desired, the comminuted battery paste can be dried. After processing and optionally washing, the comminuted battery paste can then be formed into a wafer having a size suitable for use in an axial current flow battery as described herein.

Various objects, features, aspects, and advantages of the inventive subject matter will become more apparent from the following detailed description of preferred embodiments.

### DETAILED DESCRIPTION

The inventor has now discovered that lead acid batteries can be reconditioned and reused in a conceptually simple and effective manner in which battery paste is removed from a (dis) used battery, processed, and after processing placed back into a reusable battery assembly. Typical reusable battery assemblies may be configured to have a sealable housing that encloses a plurality of bipole electrodes, an anode, and/or a cathode, and/or may be configured such that the bipole electrodes, the terminal anode and/or cathode are sealingly held in a compression mechanism that retains and compresses the plurality of bipole electrodes in a stacked configuration.

Therefore, and viewed from a different perspective, the inventor contemplates a battery design that enables assembly and disassembly of the battery in a manner that allows removal of the battery paste (typically at the end of service life) and replacement with new or reconditioned battery paste, while reusing at least some of the bipole electrodes and terminal anode and cathode. Furthermore, it is contemplated that additional components of the batteries can also be reused, and it is especially contemplated that such reused components include the housing, a compression mechanism, and/or other components that do not participate in the electrochemical reaction of the battery. Consequently, it should be recognized that preferred batteries contemplated herein can not only be disassembled in a non-destructive manner at the end of service life or other predetermined point in time, but also that most, if not all of the components of the battery can be reused, thereby avoiding the need for conventional recycling. As such, contemplated devices and methods will allow for the first time the option of servicing a battery to restore the battery to new or near-new condition without having to destroy a battery and/or to recover metallic lead as is commonly done in the art.

For example, a battery may be formed in some embodiments from a sealable housing where the housing is formed as a single unit that can be assembled and disassembled in a non- destructive manner, while in other embodiments the sealable housing is formed from a number of frames that hold a cathode, an anode, a separator, or a bipolar electrode, and wherein stacking of multiple frames forms and seals the housing. Therefore, and regardless of the specific configuration of the housing, it should be appreciated that in preferred aspects the physical integrity of the housing or housing portions and the electrodes of the battery can be maintained in a disassembly process while existing paste can be removed and replaced with new or reconditioned battery paste for reassembly into a reusable/reconditioned battery. In still other embodiments, a battery is formed from a plurality of bipole electrodes in which each of the bipole electrodes further contains a seal that circumferentially encloses the PAM and/or the NAM of the battery. The bipole plates are then stacked and sealingly retained in a compression mechanism to allow for easy disassembly and reassembly after replacing the used battery paste with reconditioned battery paste.

In this context, it should be appreciated that the particular type of lead acid battery is not limiting to the inventive subject matter, but that the type of battery may vary considerably. Therefore, configurations suitable for use herein include conventional lead acid batteries such as those described in U.S. Pat. No. 3,598,653, U.S. Pat. No. 4,485,156, U.S. Pat. No. 4,576,879, U.S. Pat. No. 4,401,730, and U.S. Pat. No. 3,981,742, as well as bipolar-type battery configurations such as those with quasi-bipole configuration as described in US 2011/0305927, lead-filled plastic honeycomb configuration as shown in EP 0607620, batteries where two opposing and electrically connected webbings were arranged on either side of a non-conductive plastic plate as shown in EP 0848442, and those as taught in U.S. Pat. No. 5,126,218 where electrically conductive plugs comprising sub-stoichiometric titanium dioxide materials were used to provide a non-conductive light-weight carrier with conductive pathways connecting both sides of the carrier.

In still further examples, valve-regulated lead acid (VRLA) batteries are also deemed suitable for use herein, and examples include among others those described in WO 2011/109683, US 2018/0366706, US 2016/0329540, US 2005/0271935, and US 2012/0052352. Consequently, the nature and particular type of battery paste will vary to at least some degree, and suitable battery paste compositions include those described in US 2007/0269592, U.S. Pat. No. 6,531,248, U.S. Pat. No. 4,323,470, and U.S. Pat. No. 3,702,265, among others.

Consequently, it should be appreciated that batteries suitable for use with the processes presented herein can be conventional batteries that are slated for disposal or recycling, and may therefore include any form factor and type such as 12V appliance batteries, 24V automotive batteries, 48V e-bike batteries, 120V/240V power backup batteries, etc. For example, and especially for the purpose of procuring lead paste for reconditioning, it is contemplated that the battery is a disused conventional battery that is opened, typically via some form of breaking or comminution. The paste is then separated from the remaining components, typically via density-based separation process (e.g., flotation, cyclone separation, etc.) and plastic and metal components (e.g., busbar, grid, contacts) can be recovered and cleaned up as needed. As will be readily appreciated, the sulfuric acid recovered from the comminuted batteries can also be reused for reconditioned batteries, or neutralized to form a sulfate product (e.g., gypsum).

Alternatively, and more preferably, batteries of all form factors can also be designed for reuse and may therefore have a configuration that allows for non-destructive opening and reassembly to form a reconditioned and sealed (i.e., fluid tight) battery. Of course, it should be recognized that such batteries can be configured in numerous forms, including batteries with a removable top, bottom, and/or side wall, which may or may not include one or more electrodes or separators couped to the top, bottom, and/or side wall. Electrodes in such battery configurations may be separable form the housing as single electrodes, electrode packs, and/or may be permanently or temporarily coupled to a busbar. Most typically, the housing will further include a retaining structure that retains the (bipole) electrodes in a fixed spatial arrangement (preferably under some degree of compression).

In some embodiments, the electrodes (monopolar or bipolar) and/or separators will each be coupled to a respective frame having a thickness that is greater than that of the electrode and/or separator and can therefore form, when stacked into an assembly, a battery in which the frame portions will contribute to form a space for the battery paste. Most typically, the frames in such batteries will be configured to form sealed spaces that contain the battery paste. Therefore, reconditioned battery paste can be added frame-by-frame in an automated process. Regardless of the particular manner of assembly, it should be recognized that the batteries suitable for use herein can be at least partially disassembled to so allow for removal of the battery paste and to also allow for adding new or reconditioned battery paste. Reassembly will then produce a reusable/reconditioned battery. In further embodiments, the electrodes need not necessarily provide a frame component, but may instead comprise a seal that circumferentially encloses the PAM and/or the NAM, and that upon compression of a stack of electrodes, will sealingly enclose the PAM, separator, and NAM.

Upon disassembly of the batteries (which may be conventional or a battery according to the inventive subject matter), the (dis) used battery paste will most typically be from partially or fully discharged batteries. As such, the battery paste used for reconditioning will predominantly comprise lead sulfate, and to a lesser degree lead dioxide, often in a microgranular and/or crystalline form that may have an average particle size of at least 0.5 mm, or at least 0).7 mm, or at least 0.9 mm, or at least 1.2 mm, or at least 1.5 mm, or at least 2.0 mm, and even larger. As will be readily appreciated, where the active material has formed crystalline deposits, the material will no longer participate in the ordinary charge/discharge cycles and may become dendritic and even impact/compromise separator function. To restore the battery paste into an electrochemically useful form, it is therefore contemplated that the battery paste will be comminuted to a desirable size. Most preferably, the average particle size will be between 25-50 μm, or between 25-100 μm, or between 50-200 μm, or between 50-500 μm, or between 100-500 μm, or between 250-750 μm, or between 250-1,000 μm, or between 500-1,000 μm. Thus, preferred particle sizes after comminution include sizes of less than 1,500 μm, or less than 1,000 μm, or less than 700 μm, or less than 700 μm, or less than 500 μm, or less than 300 μm, and even smaller (but typically larger than 25 μm).

In further contemplated aspects, it is also noted that the dis (used) battery paste may be washed prior to and/or after comminution, and suitable washing fluids will typically include water, aqueous solutions of citric acid and/or sulfuric acid, or a deep eutectic solvent including Type I, Type II, Type III, or Type IV salts. Moreover, it is contemplated that where needed or desired, the wash step may also include an optional step of reduction of lead dioxide to lead oxide using appropriate reducing agents such as sulfite or hydrogen peroxide. It should also be appreciated that the so reconditioned material can be stored in washed form, dried form, or in sulfuric acid (which may at least in part contain sulfuric acid form old (dis) used batteries). Once reconditioned, the lead paste can then be used in the assembly of a (preferably re-used) battery. Of course, it should be recognized that while it is preferred that at least some of the battery paste in a (preferably re-used) battery will be the reconditioned paste, newly prepared battery paste may also be included.

As will be readily appreciated, in some embodiments the electrodes may be conventional electrodes as known in the art and these electrodes are re-used in a reconditioned battery, particularly where the performance degradation was predominantly due to degradation of the active materials. However, in more preferred embodiments, the electrodes will be purpose-built reusable electrodes that have a significantly reduced propensity to pitting, slumping, thermo-mechanical compromise, and/or other form of degradation. Viewed from a different perspective, contemplated electrodes will provide chemical and mechanical resilience that allows for their reuse. Of course, it should be noted that such electrodes may be configured as an anode, a cathode, or as a bipolar electrode.

Most typically, electrochemical and mechanical stability of the electrodes can be achieved by use of a continuous transition metal Magneli phase suboxide layer that is coupled to an electrically conductive substrate. Suitable conductive substrates will typically comprise a metal or metal alloy. For example, preferred conductive substrates are or comprise titanium, aluminum, copper, and/or stainless steel. Such metals may also include additional structure or structural elements to increase mechanical stability (e.g., honeycomb grid in stainless steel, foamed aluminum plates, etc.).

The skilled artisan will be apprised as to various manners of forming a transition metal Magneli phase suboxide layer onto a conductive substrate, including plasma coating, reactive sputtering, sol/gel deposition, etc. For example, coating can be done by flash spark plasma sintering or conventional spark plasma sintering (see e.g., Scripta Materialia Volume 146, 15 Mar. 2018, Pages 241-245). In other embodiments, coating can be performed using plasma vapor deposition from titanium suboxide-based targets as described in EP 1614763, or by reactive sputtering (typically in the presence of a controlled oxygen quantities) from a transition metal target as described in US 2017/0067593 and elsewhere (e.g., Geraghty et al., “Preparation of suboxides in the Ti-O system by reactive sputtering”, Thin Solid Films, vol. 40, January 1977, pp. 375-383: or ACS Omega 2021, 6, 4161-4166).

Most preferably, the transition metal Magneli phase suboxide layer has a thickness of between 10-5,000 nm or between 10-2,500 nm, such as between 10-50 nm, or between 50-200 nm, or between 100-500 nm, or between 500-1,000 nm, or between 1,000-1,500 nm, or between 1,500-2,000 nm, or between 2,000-3,000 nm, or between 3,000-4,000 nm, or between 4,000-5,000 nm, and even thicker. In preferred aspect of the inventive subject matter, the transition metal in the Magneli Phase transition metal suboxide is titanium and/or vanadium and will have a formula of TiₙO₍₂ₙ₋₁₎ where (4≤n≤10) or VₙO₂ₙ₋₁ (3≤n≤9). Especially preferred continuous layers will be Ti₄O₇. Of course, it should also be noted that the Magneli phase suboxide layer may also be doped with one or more dopants, and particularly contemplated dopants include niobium, platinum, palladium, vanadium, ruthenium, silver, chromium, gallium, etc. Most typically, the ratio of titanium to dopant will at least 90:10, or at least 95:5, or at least 98:2, or at least 99:1. Therefore, and viewed from a different perspective, suitable layers beyond Magneli Phase transition metal oxides include mixed metal oxides and especially those in which the two or more metals have substantially different atomic radii such as mixed metal oxides formed from Niobium, titanium, vanadium. For example, contemplated mixed metal oxides include NbₓTi_{y}O_{z}, NbₐV_{b}O_{c}, with a, b, and c independently being between 0.01 and 99.98, and more typically with a and b independently being between 1 and 3, and c being between 5 and 10, and with x, y, and z independently being between 0.01 and 99.98, and more typically with x and y independently being between 2 and 5, and z being between 5 and 10.

In that regard, it should be noted that a continuous Magneli phase suboxide layer is different from a material in which or upon which a plurality of Magneli phase suboxide particles form a conductive path. For example, continuous layers will typically be produced in a vapor deposition process, a (reactive) sputtering process, a chemical deposition process (e.g., sol-gel process). Where the layer is deposited by a sol/gel process (preferably a continuous end-to-end process using a rolled stock of conductive substrate), suitable thicknesses include ranges of between 200-500 nm, or between 500-1,000 nm, or between 1-10 μm, or between 10-50 μm, or between 50-200 μm, or between 100-500 μm. Exemplary sol/gel processes include those in which a liquid phase contains tetrahydrofuran (THF), 1-butanol, 2-butanol, or toluene, and optionally water, and dispersed in the liquid phase are alkoxide-modified titanium suboxide (e.g., ethoxide group or isopropoxide modified). That composition is then applied to the conductive substrate and heated (typically under oxygen depleted atmosphere to a temperature below: 600° C.) to produce polycondensates.

Consequently, it should be noted that the continuous layer will not only enable very high and uniform in-plane (relative to the substrate) conductivity across substantially the entire layer, but also enable very high and uniform transverse conductivity across the entire layer. Moreover, due to the continuous nature and manner of formation of the layer on the conducive substrate, electric contact between the continuous Magneli phase suboxide layer and the conductive substrate is substantially uniform. Advantageously, such formed layers will also exhibit significant mechanical stability under strain and stress and will resist cracking or delamination that may otherwise be encountered with particle based layers.

With respect to the Magneli phase transition metal coating it should be appreciated that such material provide numerous benefits, including inhibition of corrosion of the underlying (primarily structural) substrate, conductivity for electrons into and out of the active material, adhesion to both the active materials and the substrate, and lack of chemical reactivity with the active materials and/or electrolyte(s), which avoids detrimental side reactions. Moreover, it should be noted that by having a thin coating of Magneli phase transition metal the use of a broad range of substrate materials is now enabled (e.g., may be selected for cost, structural, production, thermal and/or other parameters). Therefore, while the inventor currently prefers metallic foils, alternate materials such as silicon wafers are also deemed suitable along with various conductive polymers or other dimensionally stable and conductive materials.

In this context, it should be further appreciated that such materials will not only substantially prevent degradation of the electrode surface but also enable the use of lighter materials (as opposed to traditional lead electrodes) and with that may increase power densities to 80-100 Wh/kg. As these electrodes are not only dimensionally and electrochemically extremely robust and effective, use of the electrodes over multiple life cycles of a battery is possible (e.g., same electrode can be used over at least 10, or at least 20, or at least 30, or at least 50, or at least 100 paste exchanges with reconditioned paste). As a consequence, thermal and electrochemical recycling processes can be entirely avoided, and recycling of a battery is as simple as replacement of the paste with reconditioned paste as described above.

In addition to the numerous benefits of Magneli phase suboxides on electrodes, it should also be recognized that these materials can also provide several benefits where they are used as an additive to the lead paste, and especially in the form of (meso) porous particles (such as Magneli phase titanium suboxide or vanadium suboxide as noted above). For example, the reconditioned battery paste includes a plurality of porous Magneli Phase transition metal suboxide particles dispersed within the lead containing material, wherein the transition metal is titanium and/or vanadium. In some embodiments, the porous suboxide particles are mesoporous suboxide particles, and/or the porous suboxide particles may have an average particle size of between 5-150 μm, or between 25-500 μm. In further embodiments, the porous suboxide particles may be present in an amount of between 0.1% and 5% or between 1% and 20% of the weight of the lead containing active material. Preferably, where the transition metal is titanium, the titanium suboxide may have a formula of TiₙOₙ₋₁, with n being an integer in the range of 4-8 (most preferably Ti₄O₇).

Notably, the porous particles are not only conductive and chemically and dimensionally stable under the aggressive operating conditions of a lead acid battery, but also provide for an electrolyte reservoir that helps reduce pH excursions towards a neutral or even alkaline pH. Consequently, it should be appreciated that batteries with such additive will exhibit increased electrode performance and lifetime, increased number of charge/discharge cycles at performance specification, and/or improved deep cycling performance. As will be readily appreciated, such advantages will be present regardless of the type of lead acid battery, and typical implementations may be found in monopolar and bipolar battery configurations.

In preferred embodiments, the additive will be porous Magneli Phase suboxide particles with a size that is preferably in the sub-mm range, such as titanium or vanadium suboxides. In such use, it is generally contemplated that the porous suboxide particles are present in an amount of between 0.1% and 30% of the weight of the lead containing active material, for example, in an amount of between 0.1-1.0%, or between 1.0-5.0%, or between 5.0-10.0%, or between 7.5-15.0%, or between 10-20%, or between 15-25%, or between 10-30%, or even higher. Therefore, contemplated battery paste compositions will include porous Magneli Phase transition metal suboxide particles in an amount of at least 1%, or at least 5%, or at least 7.5%, or at least 10%, or at least 15%, or at least 20%, or at least 25%, or even higher.

With respect to suitable conductive substrates upon which the suboxide layer is formed, it is generally contemplated that all conducive materials are deemed suitable for use herein and particularly include various metals and metal alloys. For example, the conductive substrate may be formed from or comprise stainless steel, copper, aluminum, and/or titanium. In that regard, it should be particularly recognized that use of such materials is particularly advantageous as these materials will impart significant mechanical and dimensional resilience and stability into the electrodes, which was heretofore not achieved. Moreover, the conductive substrate with coating is also chemically extremely stable and inert to the acidic environment and severe oxidative conditions. In addition, electrodes with contemplated conductive substrates that are coated with a continuous layer of a Magneli phase transition metal do not need a lead layer, lead foils, and/or lead plugs as are commonly found in other lead acid battery electrodes, which will substantially reduce the weight of an electrode and avoid issues associated with pitting or slumping of lead on an electrode. Thus, contemplated electrodes can be formed without the use of lead.

In most embodiments, the transition metal Magneli phase suboxide layer is a continuous layer that extends over at least 50%, or at least 60%, or at least 70%, or at least 80%, or at least 85%, or at least 90%, or at least 95% of the surface area of at least one side of the conductive substrate, and on both sides where the electrode is a bipolar electrode. As will be appreciated, the particular size and dimension of the (bipole) electrode may vary considerably, and the capacity, desired charge/discharge characteristics, and cycle behavior will at least in part determine the specific size and geometry. However, it is typically preferred that the conductive substrate will be configured as a plate (i.e., thickness substantially smaller than length and width) that may have a square, rectangular, or round shape. Most typically, contemplated conductive substrates will have a thickness of between 0.01 mm and 5 mm, such as between 0.01 mm and 0.1 mm, or between 0.1 mm and 0.5 mm, or between 0.5 mm and 1.0 mm, or between 1.0 mm and 2.0 mm, or between 2.0 mm and 3.0 mm, between 3.0 mm and 4.0 mm, between 4.0 mm and 5.0 mm, and in some cases even thicker. Likewise, the surface area of the conductive substrate may vary considerably, and suitable areas include those of between 10 cm² to 100 cm², or between 100 cm² to 250 cm², or between 250 cm² to 1,000 cm², or between 1,000 cm² to 5,000 cm², or between 5,000 cm² to 10,000 cm², or between 10,000 cm² to 50,000 cm², and even larger. Consequently, the first and second surface areas of the Magneli phase transition metal coating on the substrates will have a similar size and may be between 10 cm² to 100 cm², or between 100 cm² to 250 cm², or between 250 cm² to 1,000 cm², or between 1,000 cm² to 5,000 cm², or between 5,000 cm² to 10,000 cm², or between 10,000 cm² to 50,000 cm², or between 50,000 cm² and 100,000 cm², and even larger.

In an exemplary configuration for a lead acid bipolar battery, a plurality of bipole electrodes will be sandwiched between a terminal anode and a terminal cathode, and a typical amount of bipole electrodes will be between 5 and 50 bipoles. Of course, such lead batteries will further include a number of respective separators placed between the NAM on one bipole electrode and the PAM on another bipole electrode. Most preferably, the separator will be compression resistant, and suitable compression resistant separators include AGM (absorbent glass mat) separators, however, other separators known in the art are also deemed suitable for use herein. As will also be readily appreciated, the separator may further include a liquid or gelled electrolyte as, for example, described in WO 2010/019291. Additionally, a compression resistant spacer element may be added to the NAM for further added stability as also described in WO 2010/019291.

Regardless of the specific type and configuration of the electrode and the battery paste, it should be appreciated that the disassembly, refill, and reassembly of a reusable battery can be done in situ, especially where batteries are stationary and/or have large capacity. In other examples, a battery may be opened, paste exchanged, and resealed at a mobile facility (e.g., truck, service van, etc.), or a battery may be collected and reconditioned in a dedicated facility. Upon reconditioning, the battery may then be offered for reuse to the same or a different user. As will be readily apparent, the devices and methods presented herein will enable multiple disassembly-NAM/PAM replacement-reassembly cycles, such as for example, at least two cycles, at least five cycles, at least ten cycles, at least 20 cycles, at least 50 cycles, and even more. Therefore, the inventor contemplates that a battery service may even be offered in a manner where a battery is provided under a lease or other rental agreement. Viewed from a different perspective, energy (storage) can be provided and maintained independent of a power production facility and/or grid operation.

Consequently, it should be recognized that contemplated devices and methods allow for high cycle-life, re-usable electrodes and that the resealing technology transforms life, performance, and retained value. Moreover, incremental upgrades can be phased-in with each scheduled service. As reconditioning of the PAM and NAM uses a safe and simple, water-based active material rework process, batteries can be fully reconditioned with as-new performance characteristics. Indeed, >99% of materials and all major cost components can be reused, which transforms a 3-5 year 2500 cycle consumable, into a >20 year >10,000 cycle asset.

For example, an axial flow battery may be assembled on site or at a dedicated facility by using a plurality of bipole electrodes, wherein each bipole electrode comprises a conductive substrate that is coated with a continuous layer of a Magneli phase transition metal to so form first and second surface areas on the bipole electrode. Positive active material (PAM) and negative active material (NAM) are then coupled to the first and the second surface areas, respectively (e.g., using preformed wafers of PAM and NAM matching the first and second surface areas). In this context, it should be appreciated that the PAM and NAM can be different materials as are commonly found in charged batteries, or reconditioned paste as described above that can be used as the active materials (in which case the PAM and NAM is the same). To ensure proper operation as a bipole battery, the bipole electrodes are sealed to retain the PAM/NAM and electrolyte, and in most typical aspects, the seal is an elastomeric seal that is coupled to the bipole. Among other choices, gaskets, bellow seals, O-rings with matching gland, or labyrinthine seals may be used, so long as the seal sealingly couples the bipole electrodes and so long as the seal circumferentially encloses (and typically follows the shape of) the PAM and/or the NAM. In most cases, a fluid tight seal is formed as the bipoles are stacked and compressed. The bipole electrodes are then stacked with two bipoles being interlaced by a separator (e.g., AGM with liquid or gelled electrolyte) that separates the NAM of one electrode form the PAM of another electrode. As will be readily appreciated, the stacking can be performed outside a housing, or progressively within a housing. Regardless of the specific nature or presence of a housing, it is generally preferred that the stacked electrodes will be subjected to compression to so seal the assembly. Preferably, the compression can be achieved within a housing (e.g., using a tight fit of the stack in a retaining structure within the housing) or with a compression mechanism that retains and compresses the bipole electrodes in the stacked configuration (e.g., via compression rods or a compression ram). Therefore, the compression mechanism may be an external mechanism such as an exoskeleton with tension rods or a housing with compression ram, but may also be integral to the stack (e.g., using insulated or non-conductive) rods extending through a portion of the conductive substrate that include a tensioning mechanism such as a clamp or threaded nut. Due to the resilient nature of the conductive substrate, the continuous layer of the Magneli phase transition metal, and the compression resistant separator, structural and functional integrity is retained over a large number of disassembly-NAM/PAM replacement-reassembly cycles.

Therefore, it should be appreciated that the devices, systems, and methods presented herein will allow servicing an axial current flow battery in a conceptually simple and effective manner. For example, where such batteries and devices are installed, the compression mechanism of the frame and/or the housing is used to decompress and release the plurality of bipole electrodes. Once the places are released and separated from each other, one or more of the PAM and NAM can be replaced with new or reconditioned PAM and NAM. In addition, and where desired, the seal, the separator, and/or one or more bipole electrodes can also be replaced with new of refurbished parts. Once all required or desired replacement is finished, the bipole electrodes are then stacked along with the seals and separators to reassemble the electrode stack to a functional battery that can then be put back into operation after using the compression mechanism to retain and compress the bipole electrodes in the stacked configuration.

Viewed from a different perspective, it should be appreciated that batteries, and especially relatively large batteries can be serviced on site rather than replaced with a new battery along with the waste of an old battery or the need for recycling an old battery. Consequently, it should also be appreciated that an energy consuming entity can be serviced on site. For example, contemplated entities include golf carts, automobiles, trucks, train engines, consumer power backup batteries, residential power supply batteries, grid load leveling batteries, and industrial power backup batteries. In such method, the battery is located and optionally removed, and at least some of the active material of the located battery is replaced with reconditioned active material upon which the battery can be re-installed into service. While such servicing can be entirely done on site, it is also contemplated that a replacement battery can be installed and the old battery is serviced off site.

While single battery units (i.e., battery assembly in a single housing or single frame) are especially contemplated, it should be recognized that multiple units are also deemed suitable for use herein, wherein the multiple units are electrically coupled to each other in series or in parallel to increase the available voltage or current. For example, where an electrical car charging station has a desired voltage of between 200-600V or of about 1,000V, multiple batteries serially connected into a single stack on a rack or other retention mechanism are contemplated in which the stack can be disassembled one battery at a time to avoid issues associated with high-voltage disconnects (such as arcing or shock hazard). Among other suitable configurations, the batteries may be slidably coupled to the rack such that the stack can be taken down one-by-one battery. To that end, the batteries may be configured such as to allow serial coupling in a rack, for example, by providing electrical connectors on the batteries that slidably engage and make electrical contact when the batteries are stacked into the rack. On the other hand, capacity may be readily increased by adding additional batteries with parallel electrical connections (that are also preferably connected in a slidable manner in a rack or other retention structure). Therefore, the inventors contemplate that the batteries, methods, and systems presented herein will be especially advantageous in numerous use scenarios, including grid load leveling stations, electric automobile charging stations, residential power supply stations, etc.

While lead acid batteries, and especially bipolar lead acid batteries are particularly contemplated herein, it should be recognized that the (bipole) electrodes presented herein may be used in numerous battery chemistries other than lead acid batteries and contemplated alternate battery chemistries include zinc-based chemistries (e.g., zinc carbon, zinc chloride, zinc air, lead zinc, etc.), lithium based chemistries (e.g., lithium ion, lithium manganese dioxide, lithium iron, lithium sulfur, lithium copper oxide, etc.), nickel based chemistries (e.g., nickel cadmium nickel oxide hydroxide, cerium zinc, nickel zinc, alkaline zinc, nickel metal hydride, etc.), silver based chemistries (e.g., silver oxide, etc.), etc. Therefore, the nature of the battery paste may vary considerably and will include those where at least one element of the redox pair is in solid form, in liquid/dissolved/solvated form, and in gaseous form. Moreover, it should be noted that contemplated electrodes may also be used in electrochemical devices other than batteries, and suitable devices include electrochemical reactors, electrochemical cells for metal winning or recovery, electrochemical salt or water splitters, etc.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

1. An axial current flow battery, comprising:
a plurality of bipole electrodes, wherein each bipole electrode is in contact with positive active material (PAM) on a first surface area and negative active material (NAM) on a second surface area opposite the first surface area;
wherein each bipole electrode comprises a conductive substrate that is coated with a continuous layer of a Magneli phase transition metal to so form the first and second surface areas;
wherein each bipole electrode further comprises a seal that circumferentially encloses the PAM and/or the NAM;
a plurality of separators, each being disposed between the PAM of one bipole electrode and the NAM of another bipole electrode;
a frame and/or a housing, wherein the frame and/or the housing includes a compression mechanism that retains and compresses the plurality of bipole electrodes in a stacked configuration; and
wherein the conductive substrate and the continuous layer of the Magneli phase transition metal maintain structural and functional integrity over a plurality of disassembly-NAM/PAM replacement-reassembly cycles for the axial current flow battery.

2. The axial current flow battery of claim 1, wherein the conductive substrate is stainless steel, copper, aluminum, or titanium.

3-14. (canceled)

15. The axial current flow battery of claim 1, wherein the conductive substrate has a thickness of between 0.5 mm and 5 mm, and/or wherein the continuous layer of the Magneli phase transition metal has a thickness of between about 10 and 500 nm.

16. The axial current flow battery of claim 1, wherein the first and second surface areas each have an area of between 50 cm² and 50,000 cm².

17. The axial current flow battery of claim 1, wherein the Magneli phase transition metal is TiₙO₍₂ₙ₋₁₎ where (4≤n≤10) or VₙO₂ₙ₋₁ (3≤n≤9).

18. The axial current flow battery of claim 1, wherein at least 80% of a surface area of the conductive substrate is coated with the Magneli phase transition metal.

19. The axial current flow battery of claim 1, wherein the continuous layer of the Magneli phase transition metal further comprises a metal catalyst selected from the group consisting of platinum, palladium, vanadium, ruthenium, and silver.

20. The axial current flow battery of claim 1, wherein the seal is an elastomeric seal, and optionally wherein the seal is coupled to the bipole electrode via a seal retaining structure in the bipole electrode.

21. The axial current flow battery of claim 1, wherein the plurality of disassembly-NAM/PAM replacement-reassembly cycles is at least ten cycles.

22. The axial current flow battery of claim 1, wherein the separator comprises a compression resistant material.

23. The axial current flow battery of claim 1, wherein the separator comprises an absorbent glass mat.

24. The axial current flow battery of claim 1, wherein the separator comprises a liquid or gelled electrolyte.

25. The axial current flow battery of claim 1, wherein the frame and/or the housing is configured to retain between 5 and 50 bipole electrodes.

26. The axial current flow battery of claim 1, wherein the compression mechanism comprises a plurality of tension rods or one or more compression rams or compression levers.

27-55. (canceled)

56. A method of servicing an axial current flow battery, comprising:
providing an axial current flow battery of any one of claims 1-26;
using the compression mechanism of the frame and/or the housing to decompress and release the plurality of bipole electrodes;
replacing
(a) the PAM and/or NAM with new or reconditioned PAM and/or NAM;
(b) the seal;
(c) the separator; and/or
(d) the bipole electrode
stacking the bipole electrodes with the new or reconditioned PAM and/or NAM, the replaced seal, and/or the replaced separator; and
placing the stacked bipole electrodes into the frame and/or the housing and using the compression mechanism to retain and compress the bipole electrodes in the stacked configuration.

57. The method of claim 56, wherein at least two of (a), (b), (c), and (d) are replaced.

58. The method of claim 56, wherein at least three of (a), (b), (c), and (d) are replaced.

59. The method of claim 56, wherein the new or reconditioned PAM and/or NAM are provided as pre-shaped PAM and/or NAM wafers.

60. A method of servicing an energy consuming entity, wherein at least some of the energy used by the entity is provided by a lead acid battery, comprising:
locating a lead acid battery in the entity, and optionally removing the lead acid battery from the entity, wherein the lead acid battery is a battery according to any one of claims 1-26;
replacing at least some active material of the lead acid battery with reconditioned active material;
where the lead acid battery was removed,
installing the lead acid battery with the reconditioned active material, or
installing a different replacement lead acid battery that contains reconditioned active material; and
optionally recharging the lead acid battery or replacement battery; and
wherein physical integrity of the housing or housing portions and the electrodes of the lead acid battery is maintained in a disassembly process while the active material is removed and replaced with the reconditioned active material.

61. (canceled)

62. The method of claim 60, wherein in the step of replacing at least some of the active material of the battery with reconditioned active material, the reconditioned material is prepared from the active material of the battery, or the reconditioned material is prepared from an active material of a different lead acid battery.

63-75. (canceled)
